(19) United States
(12) Patent Application Publication
(10) Pub. No.: US 2016/0284319 A1
(43) Pub. Date: Sep. 29, 2016

(54) COMPENSATION METHOD FOR A DISPLAY APPARATUS

(71) Applicant: BAE Systems plc, London (GB)

(72) Inventors: Stephen Paul MASON, Rochester Kent (GB); Ian MARSHALL, Rochester Kent (GB); Paul Stewart MORANT, Rochester Kent (GB); Iain King WILMINGTON, Rochester Kent (GB)

(21) Appl. No.: 15/034,224

(22) PCT Filed: Nov. 6, 2014
(86) PCT No.: PCT/EP2014/073977

§ 371 Date: May 4, 2016

(30) Foreign Application Priority Data
Nov. 8, 2013 (EP) 13275283.3
Nov. 8, 2013 (GB) 1319731.4

(51) Int. Cl. G09G 5/22; G09G 5/10; G02B 27/01

(52) U.S. Cl. CPC G09G 5/227; G02B 27/0172; G09G 5/10; G09G 2320/066; G09G 2320/0233; G09G 2340/0407

(57) ABSTRACT

A display apparatus and method are provided for at least partially compensating for undesirable image degradation arising from the processing of a generated image prior to display at a viewing surface, such as a combiner. The degradation is such that a viewer perceives a reduction in contrast ratio of a portion of the image content appearing in one or more regions of the field of view of the display, for example against an external scene being viewed through the combiner. In the invention, control means are provided to at least partially compensate for the reduction in contrast ratio by decreasing the resolution of the portion of the generated image content intended for display in the region of perceived reduced contrast ratio prior to input to the processing function.

The present invention relates generally to a compensation method for a display apparatus, and to a display apparatus which utilises such a method.

When displaying imagery overlain on an external scene, for example using a combiner or equivalent in a head-up display system, the contrast ratio of the displayed imagery needs to be sufficient to ensure its reliable visibility against the external scene. This is because a low contrast ratio for the displayed imagery may result in it being difficult or impossible for the user of the display to easily see, or to respond to information provided in the imagery. Besides displaying imagery with a sufficiently high contrast ratio, it is desirable for the contrast ratio and/or output luminance to vary as little as possible across the display, to improve the viewing experience of the user.

According to the present invention there is provided an apparatus and method as set forth in the appended claims. Other features of the invention will be apparent from the dependent claims, and the description which follows.

According to a first aspect of the invention, there is provided a compensation method for a display apparatus, the display apparatus including a processing function which introduces undesirable degradation to a generated image being input from a display source such that a viewer perceives a reduction in the contrast ratio of a portion of the image content appearing in a region of the field of view of the display, the method comprising at least partially compensating for the reduction in the contrast ratio by decreasing the resolution of the portion of the generated image content intended for display in the region of perceived reduced contrast ratio prior to input to the processing function.

The processing may comprise optical processing, and/or signal processing. Optical processing might comprise reflection, refraction, or diffraction, amongst other optical manipulations.

The at least partial compensation may comprise adjusting an input signal used in the generation and/or display of the content. For example, the adjusting may comprise using more pixels to display content, or pixels at different output luminances.

Display content may be subjected to an anti-aliasing function prior to display. The anti-aliasing function may be varied to decrease the resolution of the content.

The content display resolution at the region may be lower than content display resolution at another, different region of the display field of view, for example for the same input display content displayed at the different regions.

The at least partial compensation might comprise ensuring that a contrast ratio between a display content luminance and a background luminance is at or above 1.2:1 (sometime referred to simply as 1.2).

The background luminance may be a luminance visible to a user through an at least partially transparent viewing surface, such as a combiner.

The at least partial compensation might additionally comprise increasing an output luminance of a display source.

The at least partial compensation may comprise increasing an output luminance of a display source (e.g. one or more emissive light sources), such that the decrease in the input resolution of the input content for display at the region, together with the increase in luminance of the display source, ensures that a contrast ratio between a display content luminance and a background luminance is at or above 1.2:1.

The at least partial compensation might comprise one or more of: increasing a dimension, increasing a size, increasing a line-width, or increasing a scale of the display content for the region.

The method might comprise determining whether, and/or to what extent, the content display resolution is lower than the content input resolution for the region of the display, by one or more of modelling and measurement, in advance of implementing the at least partial compensation.

The display apparatus may be, or may form at least a part of, a head up display.

According to a second aspect of the invention, there is provided a display apparatus for displaying an image generated at a display source, the display apparatus including a processing function which introduces an undesirable degradation to the generated image such that a viewer perceives a reduction in contrast ratio of a portion of the image content appearing in a region of the field of view of the display apparatus, the apparatus including control means for at least partially compensating for the reduction in contrast ratio by decreasing the resolution of the portion of the generated image content intended for display in the region of perceived reduced contrast ratio prior to input to the processing function.

In a typical arrangement, the image is displayed at an at least partially reflective viewing surface, such as a combiner.

The display apparatus may be, or may form at least a part of, a head-up or helmet-mounted display.

It will be clear to the skilled person that one or more features of one or more aspects or embodiments of the invention may be used in place of, and/or in combination with, one or more features of one or more other aspects or embodiments of the invention, unless such combination/replacement would be understood by the skilled person as being mutually exclusive.

For a better understanding of the invention, and to show how embodiments of the same may be carried into effect, reference will now be made, by way of example, to the accompanying diagrammatic Figures in which:

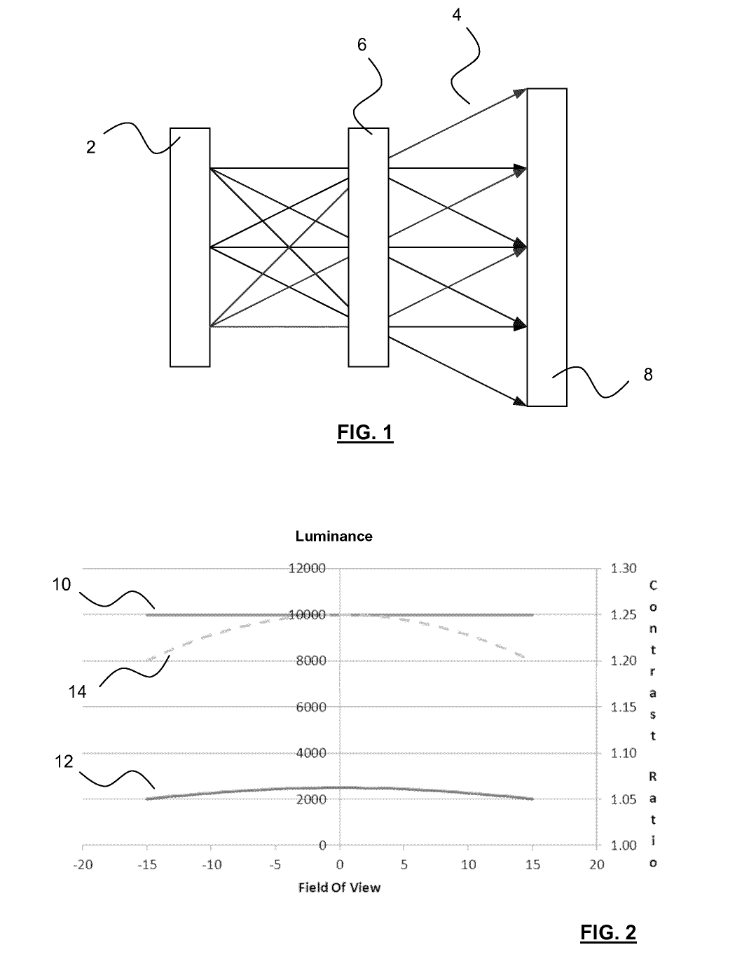

FIG. 1 depicts a schematic view of a head up display apparatus;

FIG. 2 shows a number of graphs depicting optical properties of the display apparatus of FIG. 1 for a flat-field output from the display source;

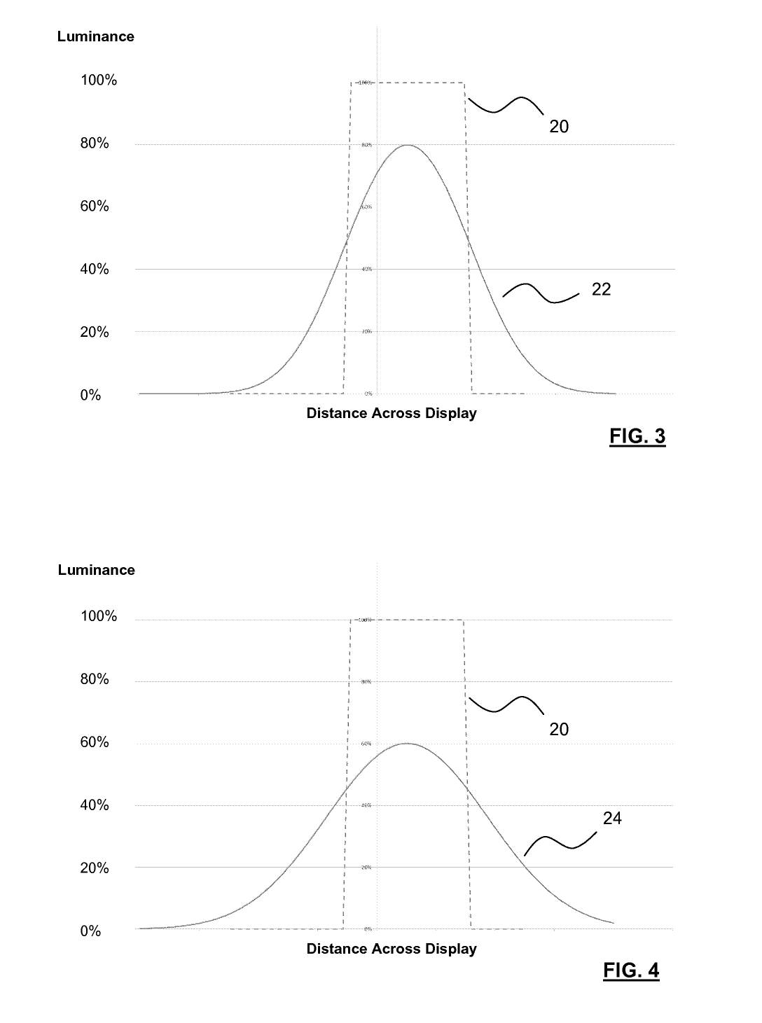

FIG. 3 is a graph showing how luminance varies in the vicinity of specific imagery being displayed at a centre of the field of view of the display apparatus of FIG. 1;

FIG. 4 is a graph showing how luminance varies in the vicinity of specific imagery being displayed toward an outer edge of the field of view of the display apparatus of FIG. 1;

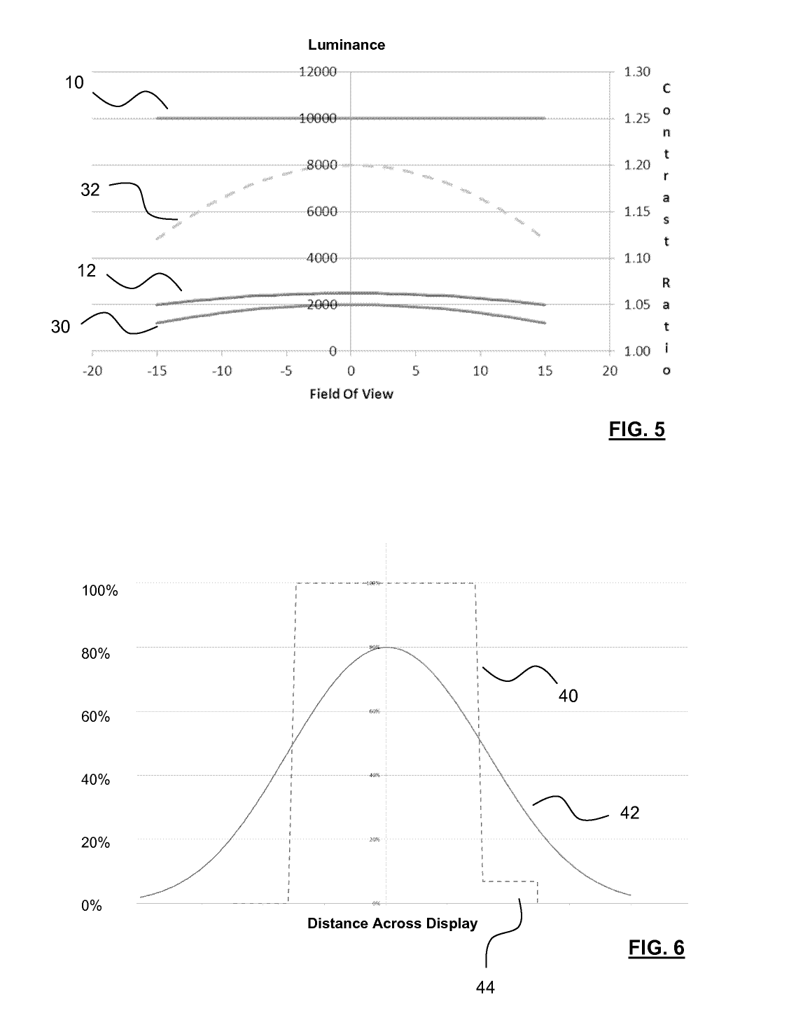

FIG. 5 shows a number of graphs depicting optical properties of the display apparatus of FIG. 1 for a flat-field output from the display source and for the output of imagery in the form of symbols from the display source;

FIG. 6 is a graph showing how luminance varies in the vicinity of specific imagery being displayed toward an outer edge of the field of view of the display apparatus of FIG. 1 in accordance with an example embodiment of the present invention; and

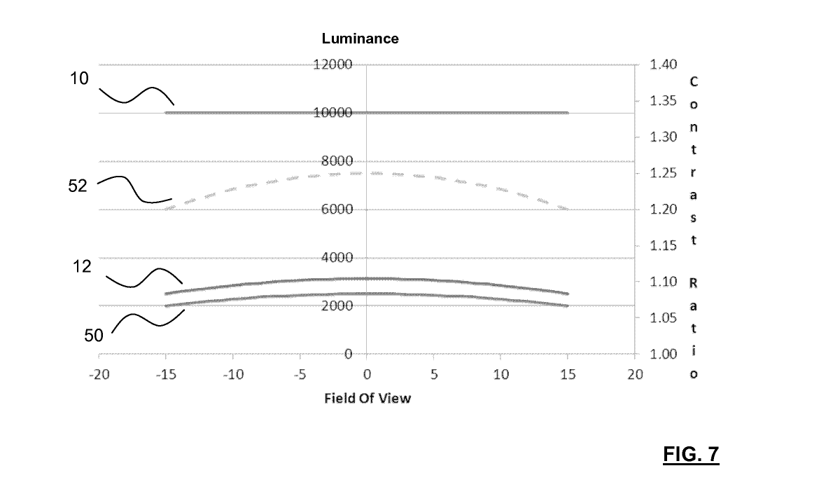

FIG. 7 shows a number of graphs depicting optical properties of the display apparatus of FIG. 1 for a compensated flat field output from the display source and for compensated output from the display source in the form of imagery content comprising symbols, in accordance with an example embodiment of the present invention.

FIG. 1 schematically depicts features of a head up display apparatus. The apparatus comprises a display source 2, for example a pixelated display source. The display source 2 may generate an image to be displayed using a pixelated array of reflective elements as provided by a Digital Micro-mirror Device (DMD) or a Reflective Liquid Crystal on Silicon (RLCoS) device and a separate source of illumination, or using a pixelated emissive display device such as one based upon Organic Light Emitting Diode (OLED) technology.

Image-bearing light emitted by the display source 2 passes through an optical system 6, including for example a collimating optics and projection optics arrangement, before being projected onto or in some other way made visible at a viewing surface 8. In describing example embodiments of the present invention below, the viewing surface 8 will be assumed to take the form of a conventional combiner, providing an at least partially reflective surface from which image-bearing light 4 output from the optical system 6 may be reflected towards a user while being at least partially transparent to light from an external scene visible to the user through the combiner 8. This enables the user to see image content displayed overlain on the external scene. However, it will be clear that other viewing arrangements may be implemented in which generated image content may be made visible by the user.

The optical system 6 may also include an arrangement of one or more mirrors, prisms or lenses to direct and condition the image-bearing light 4. The optical system 6 may also or alternatively comprise signal processing in software and/or hardware (e.g. image processing).

It is desirable that luminance of image content visible at the combiner 8 is as uniform as possible across the available field of view. This is because local reductions, resulting in reductions in contrast ratio, could lead to image content in the region of the reduction becoming difficult to discern against a bright background.

FIG. 2 is a graph schematically depicting optical properties of the apparatus of FIG. 1 in displaying a flat-field output from the display source 2 with all pixels at maximum luminance. The graph depicts a substantially constant luminance 10 of an external scene, but shows how the luminance 12 of light output from the optical system 6 may vary across the field of view of the display apparatus of FIG. 1 due to undesirable degradation by the optical system 6. The graph of FIG. 2 also shows how contrast ratio 14 varies across that field of view as a result of the variation in luminance 12.

It can be seen that the flat field luminance 12, and thus the contrast ratio 14, falls towards the edges of the field of view. This variation is due at least in part to the properties of the optical system 6 and arises for example from necessary design compromises made to reduce mass and volume of the display system, in particular when designed for use in a head-up or helmet-mounted display system. In this example, the variation is such that the contrast ratio falls from 1.25:1 (sometimes referred to simply as 1.25) at the centre of the field of view of the display apparatus to 1.20:1 at the edge of the field of view. However, this variation in contrast ratio 14 might still be acceptable, since a contrast ratio of 1.2:1 is typically deemed acceptable as a lower limit for image content contrast in daylight.

When assessing the effect of such compromises in the design of the display system, besides considering luminance and contrast variations, it is also necessary to consider the effect of such compromises on display resolution. This is achieved conventionally by determining the Contrast Transfer Function (CTF) or the Modulation Transfer Function (MTF) for the optical system 6 of the display apparatus. For a pixelated display source 2, the CTF is usually taken to provide the most appropriate basis for assessing performance of the optical system 6. The CTF is the magnitude response of the optical system to a square wave input of different spatial frequencies.

Compromises in the design of the optical system of the display apparatus can result in undesirable variations in the CTF across the field of view of the display. These variations might typically result in a viewer perceiving the image content to be less sharp at the edges of the field of view than at the centre, although variations could also occur elsewhere within the field of view. FIGS. 3 and 4 show graphically how luminance across a displayed symbol varies according to whether the symbol is displayed near the centre of the field of view of the display or towards the edges of that field of view.

Referring to FIG. 3, a graph 22 is presented showing how luminance varies in the vicinity of a two-pixel-wide line 20 being displayed at the centre of the display field of view as a percentage of the luminance available when a flat-field output at maximum luminance from the display source 2 is being displayed (see graph 12 in FIG. 2). It can be seen that the peak luminance for the line has been reduced to 80% of that for a flat field output from the display source 2.

Referring to FIG. 4, a graph 24 shows how luminance varies in the vicinity of the same two-pixel-wide line 20 when displayed at the edge of the display field of view. It can be seen that at the edge of the field of view of the display, the peak luminance has been reduced to 60% of that for a flat field output from the display source 2 at that same region of the field of view, which was itself degraded as shown (12) in FIG. 2. It can be seen that the luminance profile 24 as a whole is somewhat flatter in comparison with that (22) for the same image content when displayed at the centre of the display field of view, as shown in FIG. 3.

An overall result is that the reduction in luminance of image content toward the edge of the display results in further degradation of the contrast ratio, and also a reduction in resolution of the image content in comparison with the input resolution available at the display source 2 and/or in comparison with the resolution of the same image content displayed at other regions of the field of view, as will now be shown in FIG. 5.

Referring to FIG. 5, graphs are shown representing an overall view of optical properties of the display apparatus, in particular enabling a comparison to be made of the perceived luminance profile 12 (from FIG. 2) across the field of view for a flat-field output from the display source 2 and that, 30, for more specific image content when output from the display source 2. As with the graph of FIG. 2, the same substantially constant luminance 10 of an external scene is shown.

FIG. 5 also shows a graph 32 of the contrast ratio across the field of view for the more specific image content. From this it can be seen that the variation in contrast ratio for the more specific image content (e.g. symbology) is far greater than the variation in contrast ratio 14 for the flat-field output as shown in FIG. 2. This is to the extent that only image content displayed at the centre of field of view achieves what could be classed as a minimum requirement of 1.2:1 in terms of contrast ratio, with the contrast ratio at the edge of the field of view falling to as low as 1.12:1. In this example it may thus be very difficult for a user to view image content (e.g. symbology) being displayed at the edge of the display field of view against an external scene.

It is of course desirable to attempt to at least partially compensate for the variations in luminance and contrast ratio. For instance, it is desirable to compensate to the extent that the contrast ratio does not fall below a minimum, threshold value below which it might be difficult to perceive image content against an external scene. For instance, this minimum, threshold value might be the contrast ratio of 1.2:1 already discussed above, or a luminance required to achieve that ratio.

A conventional approach to providing such compensation would be to simply increase the luminance of the displayed content by increasing the output luminance at the display source 2, for example by increasing LED drive current or similar. This solution might indeed provide the required compensation. However, the compensation itself then has associated drawbacks. For instance, and with reference to FIG. 5, to achieve a minimum contrast ratio of 1.20:1 at the edge of the display would require a 67% increase in the overall display luminance. This is clearly a significant increase, which would clearly require a significant increase in power consumption for the display apparatus. Perhaps more importantly, the increase in power consumption would also require an associated heat dissipation increase, with resultant increase in equipment temperatures, e.g. involving the display source 2. This increase in temperature could cause reliability issues and other problems, for example in the case of head-up displays and helmet-mounted displays, where it might be difficult to easily dissipate such heat while maintaining practical functionality for the apparatus, for example a lightweight yet cost-effective construction.

An embodiment of the present invention provides a display apparatus, as described above in which degradation caused by the associated optical system 6 results in variations in perceived image contrast ratio and image resolution across the field of view of the display, but in which an at least partially compensatory adjustment is made to the imagery at the display source 2, before the image-bearing light passes through the optical system 6. The at least partially compensatory adjustment comprises decreasing the resolution of that part of the imagery content for display at the region of concern. This decrease in resolution results in an increase in luminance of such imagery content, e.g. a symbol, being displayed towards the edges of the field of view of the display, and hence an increase in the contrast ratio, but without needing to increase significantly the power required at the display source 2. The decrease in input resolution may be achieved by increasing one or more dimensions of features making up the imagery content for that region, e.g. increasing a line width through variations in an anti-aliasing function being applied to that line, such variations corresponding with variations in an observed or predicted modulation transfer function or contrast transfer function across the field of view of the display.

Example embodiments of the present invention might be described as somewhat counter-intuitive. For instance, when it is difficult to view content due to a reduction in contrast ratio and resolution as shown in FIG. 4, a notional skilled person might have expected the solution to include increasing the luminance or the resolution of the imagery generated at the display source to compensate for reductions to both measures imparted by the optical system 6. It would be not at all obvious that a decrease in the resolution of the input content actually solves the problem that is directly associated with a perceived decrease in resolution of the displayed imagery content. However, and as might now be apparent from an understanding of FIGS. 3 and 4, such an increase in the input resolution would in fact lead to a further decrease of the peak output luminance, and a further degradation in contrast ratio. The present invention avoids this issue in a simple but effective way.

An example implementation of the present invention will now be described with reference to FIGS. 6 and 7.

Referring to FIG. 6, using the example of a two pixel-wide line being displayed towards the edge of the field of view of the display, as shown in FIG. 4, a compensatory adjustment is made to increase the width of the line 20 at the display source 2 to form a line 40 that is three pixels wide. As can be seen in FIG. 6, the luminance 42 in the vicinity of the line 40 has a peak luminance comparable to that for the line 20 when displayed at the centre of the field of view of the display, as shown in FIG. 3. The increase in the number of pixels used to form features in the imagery results in an output luminance profile for each feature that is far more visible to the user against the external scene.

This decrease in resolution, which might alternatively or additionally be described as an increase in certain dimensions of features in the imagery content, might be achieved by adjusting an input signal used in the generation of the imagery at the display source 2 according to the region in the display field of view at which it is to be displayed.

As shown further in FIG. 6, the change in size/resolution of the input content does not necessarily need to be limited to using multiple pixels at full luminance output. For instance, one or more pixels 44 may be included at below the maximum luminance level, for example to finely tune the output luminance profile 42. If an anti-aliasing function is being used to adjust the pixel illumination levels in the vicinity of a symbol to be displayed, such as a line, then adjustments may be made to vary the anti-aliasing function across the field of view so that the number of illuminated pixels making up a symbol is increased, for example adding one or more pixels 44, in those regions where the CTF is known to be decreased. Embodiments of the present invention are particularly suited to the display of imagery comprising or made up from discrete symbols such as lines, shapes or characters.

By this or by other means for controlling the generation of imagery content, for example at the display source 2, as would be apparent to a person of ordinary skill in the relevant art, adjustments may be made to features to be displayed to ensure that the contrast ratio across the entire field of view of the display exceeds a minimum threshold value, for example 1.2:1 as discussed above. The increase in overall display luminance is far lower than would have been required without any compensation by decrease in imagery content resolution, significantly lower than for example the 67% increase mentioned above in relation to FIG. 5. For instance, in accordance with an example embodiment of the present invention, an overall increase in display luminance of only 25% may be incurred in achieving a contrast ratio of at least 1.2:1 across the entire field of view of the display. This will be apparent from FIG. 7.

Referring to FIG. 7, several graphs are presented to show how the optical properties described above, for example with reference to FIG. 5, may be improved in embodiments of the present invention. The same graph 10 is provided, showing the background luminance level. The graph 12 of flat field output luminance level is also shown, this level being 25% higher than the same indicative level as shown in and described with reference to FIG. 2, due to an approximately 25% increase in general output luminance for the display as compared to that unmodified display arrangement. A graph 50 of output luminance level across the display is also shown for more specific imagery content, for example symbols such as geometrical shapes, lines, dots or characters. A graph 52 is also presented showing how the contrast ratio for imagery content varies according to where it is displayed across the field of view of the display.

It is apparent from FIG. 7 that, in this particular example, the increase in overall display luminance needed to achieve the required contrast ratio of 1.2:1 across the field of view of the display reduces from the expected 67%, as in conventional approaches, to only 25%. Therefore, power consumption is reduced in comparison with conventional approaches, and so is the need for heat dissipation.

For a particular display arrangement, conventional techniques involving one or more of modelling and measurement may be applied to determine the CTF for the display and to identify those regions in a field of view of the display in which the CTF is reduced. With this information, image generation functionality may be adjusted to make compensatory changes to imagery content as discussed above. This methodology may be implemented in a controller of the display apparatus.

The compensation method may be selectively applied. For example, in a further embodiment of the present invention, the compensation may be disabled, or applied to a lesser extent when the display apparatus is being used in low-light conditions when decreasing resolution of some imagery content may not be needed or beneficial. A switch (electronic, physical, or software-controlled, for example) may be provided to allow for selective activation and deactivation of the methodology.

It will be appreciated that the exact percentages described above in relation to the required changes in output luminance, or the changes in required luminance between example embodiments and conventional approaches, are only examples. The exact percentages, including any efficiency gains or similar, will vary depending on the exact nature of the display apparatus, the required resolution changes, and so on. In any regard, it may still, nevertheless, be useful to ensure that the at least part of compensation described above ensures that the contrast ratio between the display content luminance and a background luminance is at or above 1.2 (i.e. 1.2:1). This might be achieved by reducing the resolution of the display content/increasing its size in isolation, or perhaps in combination with an increase in luminance of the display source (which includes one or more light sources thereof).

The example embodiments have been described with reference to a head up display. It will be appreciated that a head up display incorporates such displays as helmet or head mounted displays. Also, it will be appreciated that the general principles described above are also applicable to display apparatus in general, and are not necessarily limited to application to head up displays.

Although a few preferred embodiments have been shown and described, it will be appreciated by those skilled in the art that various changes and modifications might be made without departing from the scope of the invention, as defined in the appended claims.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

What is claimed is:

1. A compensation method for a display apparatus having a field of view in which, in use, image content having a contrast ratio appears, wherein the display apparatus includes a processing function which introduces a reduction in a contrast ratio of at least a portion of generated image content input to the processing function from a display source, the portion appearing in a region of the field of view of the display, the method comprising:
at least partially compensating for the reduction in the contrast ratio by decreasing a resolution of the portion of the generated image content prior to input of the generated image content to the processing function.

2. The compensation method of claim 1, wherein the processing function comprises at least one of optical processing and signal processing.

3. The compensation method of claim 1, wherein the at least partial compensation comprises adjusting an input signal used in the generation and/or display of the image.

4. The compensation method of claim 1, wherein the image content is subjected to an anti-aliasing function prior to display, and wherein the anti-aliasing function is varied to decrease the resolution of the portion of the image content for display in the region of reduced contrast ratio.

5. The compensation method of claim 1, wherein the decrease in contrast ratio arises from a decrease in luminance of a portion of the image content and wherein decreasing the resolution of the portion of the image content results in an increase in perceived luminance of the portion of the displayed image content.

6. The compensation method of claim 1, wherein the at least partial compensation comprises ensuring that a ratio between displayed image content luminance and background luminance is at or above 1.2:1.

7. The compensation method of claim 6, wherein the image content is displayed at an at least partially reflective viewing surface that is at least partially transparent to light from an external scene, and the background luminance is a luminance of said light from said external scene that is visible to a user through the at least partially transparent viewing surface.

8. The compensation method of claim 1, wherein the at least partial compensation additionally comprises increasing an output luminance of the display source.

9. The compensation method of claim 1, wherein the at least partial compensation comprises increasing an output luminance of a display source such that decreasing the resolution of that portion of the generated image intended for display in the region of perceived reduced contrast ratio together with the increase in luminance of the display source ensures that a ratio between the displayed image content luminance and a background luminance is at or above 1.2:1.

10. The compensation method of claim 1, wherein decreasing the resolution of the portion of the generated image content includes one or more of:
increasing a dimension of the portion of the image content;
increasing a size of the portion of the image content;
increasing a line width of the portion of the image content; and
increasing a scale of the portion of the image content.

11. The compensation method of claim 1, wherein the method comprises determining whether, and/or to what extent, the displayed image content resolution is lower than the generated image content resolution for the region of the display field of view by at least one of modelling and measurement, in advance of implementing the at least partial compensation.

12. A display apparatus for processing image content generated at a display source and displaying the processed image content onto a field of view of the display apparatus, said generated image content having a contrast ratio, the display apparatus comprising:
a processing function configured to receive the image content from the display source and to process said image content, whereby the processing function introduces a reduction in a contrast ratio of at least a portion of the processed image content appearing in a region of the field of view of the display apparatus; and
a control mechanism configured to at least partially compensate for the reduction in contrast ratio by decreasing a resolution of the portion of the generated image content prior to input to the processing function.

13. The display apparatus of claim 12, wherein the processed image content is displayed at an at least partially reflective viewing surface.

14. The display apparatus of claim 12, wherein the display apparatus is, or forms a part of, a head-up or helmet-mounted display.

15. (canceled)
